(19) United States
(12) Patent Application Publication
(10) Pub. No.: US 2025/0332496 A1
(43) Pub. Date: Oct. 30, 2025

(54) Hockey Puck with Camera System

(71) Applicant: Craig Michael Lyons, Dana Point, CA (US)

(72) Inventor: Craig Michael Lyons, Dana Point, CA (US)

(21) Appl. No.: 19/184,829

(22) Filed: Apr. 21, 2025

Related U.S. Application Data
(60) Provisional application No. 63/637,972, filed on Apr. 24, 2024.

(51) Int. Cl. A63B 67/14; A63B 69/00; H04N 7/18

(52) U.S. Cl. CPC A63B 67/14; A63B 69/0026; H04N 7/181; H04N 7/183; A63B 2220/806; A63B 2220/808; A63B 2225/50

(57) ABSTRACT

A hockey puck with camera system for capturing images from a playing surface and transmitting the images to a display device has a puck body with a top surface and a bottom surface that are joined by an annular outer perimeter. At least one opening is formed through the annular outer perimeter and into an electronics chamber within the puck body. The electronics chamber contains at least one camera that can collect light through the at least one opening, and a transmittal device for transmitting images taken by the at least one camera to the display device.

### CROSS-REFERENCE TO RELATED APPLICATIONS

This application for a utility patent claims the benefit of U.S. Provisional Application No. 63/637,972, filed Apr. 24, 2024.

### BACKGROUND OF THE INVENTION

### Field of the Invention

This invention relates generally to hockey pucks, and more particularly to a hockey puck with camera system for capturing and transmitting images to a display.

### Description of Related Art

Cameras are often provided in many locations throughout an arena for capturing video footage of the sport being played. For example, Monari, U.S. Pat. No. 9,167,228, teaches a real time system to televise sporting events from amongst the players on a playing field. Sports paraphernalia that are ordinarily used by the players on the playing field are instrumented with a variety of TV cameras, microphones, and bi-directional communication electronics. Sports paraphernalia specifically discusses ice hockey pucks (also footballs, baseballs, baseball bases, etc.). The instrumentation is built into and contained within the sports paraphernalia. The instrumented sports paraphernalia televise signals to an antenna array relay junction, which relays the signals to a remote base station where they are processed and finally broadcast to a TV viewing audience. The cameraman in the remote base station exercises command and control over the functions of the instrumented sports paraphernalia. There are other related patents claim claiming hockey pucks in more detail, such as Monari, U.S. Pat. No. 8,959,555.

Houlihan, U.S. Pat. No. 10,722,773, teaches a system for hockey training wherein a hockey puck includes one or more sensors that allows the system to identify the location of the puck. The puck may include a microprocessor and wireless transmitter to allow for transmission of the sensor data via wireless transmission to an external electronic device. A software application running on an electronic device (e.g., smart phone or tablet), receives the sensor data and incorporates the information into a game-like or training application. This application can display to the user which location the object should be for the game. This application can also analyze which patterns the player has difficulties with and suggest certain patterns and other advice to help the player to improve their skills. Among many other uses, this system could provide a way for a player to train hockey stickhandling skills.

There are also many patents on transmitting various forms of electromagnetic radiation for the purposes of tracking the location of a hockey puck. Honey, U.S. Pat. No. 5,953,077, for example, teaches a system for displaying a hockey puck on a camera.

### SUMMARY OF THE INVENTION

The present invention teaches certain benefits in construction and use which give rise to the objectives described below.

The present invention provides a hockey puck with camera system for capturing images from a playing surface and transmitting the images to a display device. The hockey puck with camera system comprises a puck body with a top surface and a bottom surface that are joined by an annular outer perimeter. At least one opening is formed through the annular outer perimeter and into an electronics chamber within the puck body. The electronics chamber contains at least one camera that can collect light through the at least one opening, and a transmittal device for transmitting images taken by the at least one camera to the display device.

A primary objective of the present invention is to provide a hockey puck with camera system having advantages not taught by the prior art.

Another objective is to provide a hockey puck with camera system that includes a transmittal device for live streaming of images captured by cameras within the hockey puck.

A further objective is to provide a hockey puck with camera system that includes an imaging program that automatically formats streamed images to a display for training.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention.

FIG. 1 is a perspective view of a hockey puck according to one embodiment of the present invention;

FIG. 2 is a block diagram of one embodiment of a hockey puck with camera system that embodies the present invention;

FIG. 3 is an exploded perspective view of the hockey puck, showing an internal electronics component;

FIG. 4 illustrates a player view of a goal and goalie, with the hockey puck positioned in front of the player; and

FIG. 5 illustrates the same view of the goal and the goalie shown in FIG. 3, but from the perspective of one of the cameras of the hockey puck, which may be shown on the display of FIG. 2.

### DETAILED DESCRIPTION OF THE INVENTION

The above-described drawing figures illustrate the invention, a hockey puck with camera system that includes a hockey puck with at least one embedded camera for capturing images from a playing surface and transmitting the images to a display device.

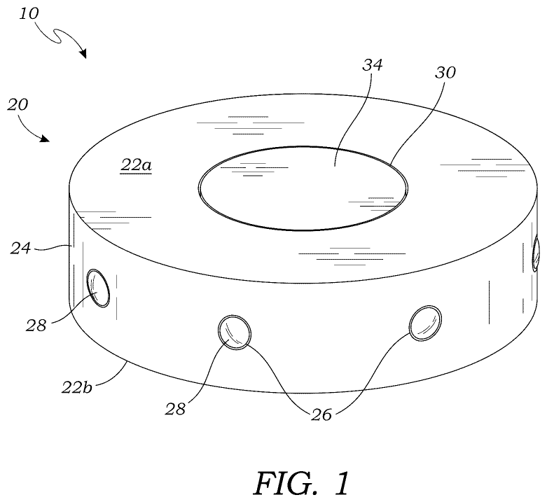

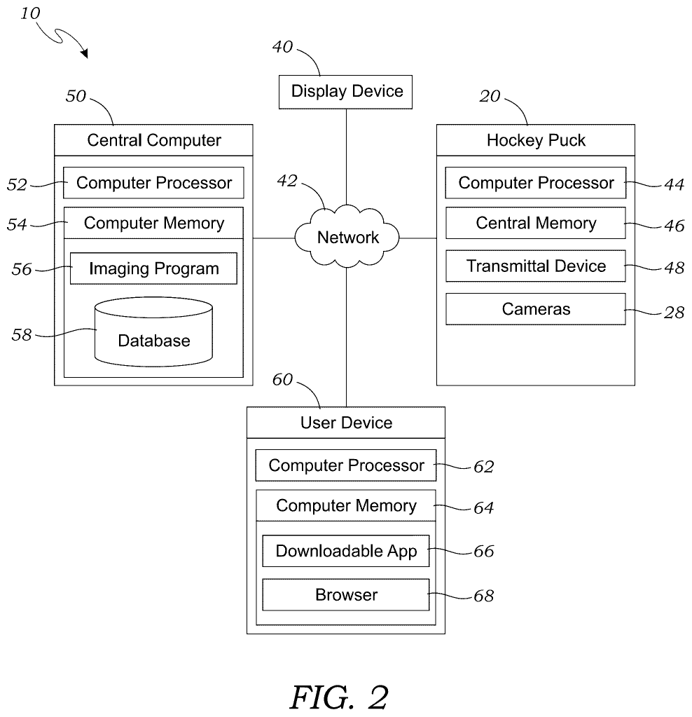

FIG. 1 is a perspective view of a hockey puck with camera system 10 according to one embodiment of the present invention. As shown in FIG. 1, the system 10 comprises a puck body 20 that is generally similar to a standard hockey puck, having a top surface 22a and a bottom surface 22b that are joined by an annular outer perimeter 24. The annular outer perimeter 24, or sidewall, includes at least one hole 26 which allow at least one camera 28 (shown in FIG. 2) to capture images around the hockey puck 20. In this embodiment, there are a plurality of holes 26, two or more, in this case more than 3 holes, spaced around the perimeter. The light from the holes 26 may be directed to a single camera, or each hole may be associated with one of a plurality of cameras 28.

For the purposes of this application, the term “playing surface” refers to any form of ground or floor upon which the game of hockey, or similar sports/games, can be played, including but not limited to ice rinks, roller rinks, indoor or outdoor courts, fields, etc.

FIG. 2 is a block diagram of the hockey puck with camera system 10. As shown in FIGS. 1-2, the hockey puck 20 is operably connected to a display device 40 via a network 42, and may also be connected to other components, such as a central computer 50 and a user device 60, each discussed further below.

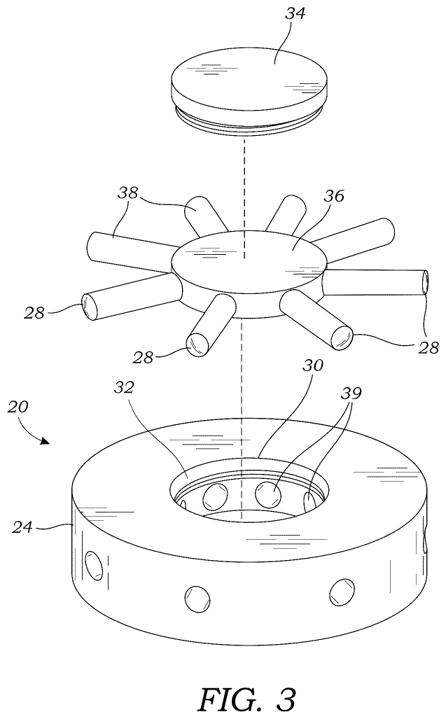

As shown in FIGS. 1-2, in this embodiment, there may be an opening 30 in the top and/or bottom surface 22, or via the perimeter 24, that gives access to an electronics chamber 32 (shown in FIG. 3) within the puck body 20. The electronics chamber 32 contains the at least one camera 28 connected to a computer processor 44 and a computer memory 46, and a transmittal device 48 for transmitting images taken by the at least one camera 28 via the network 42. Any simple computer circuit, microcontroller, or similar hardware known in the art may be used for this purpose.

In some embodiments, the opening 30 of the electronics chamber 32 includes a cover plate 34 for securing and/or sealing the electronic components within the puck body 20. The cover plate 34 may be in the form of a lens to better capture images around the hockey puck 20. As used in this application, the term “images” is defined to include video footage as well as still frame images. The puck body 20 may be constructed in such a way that the electronics are within a removable piece of the center of the puck to allow for easy manufacturing and replacement. The electronics may, in some embodiments, be capable of being snapped in or screwed in, and should be durable enough to withstand the significant physical impacts experienced by a typical hockey puck during routine use.

As illustrated in FIG. 1, in this embodiment, the plurality of holes 26 are formed through the annular sidewall 24 and into the electronics chamber 32 to allow the camera(s) 28 to see outside of the electronics chamber 32. In some embodiments, there is a camera 28 positioned within each of the plurality of holes 26; in other embodiments, the camera(s) 28 is positioned only in the electronics chamber 32, i.e., as in the case of a 360 degree camera or a cluster of outwardly-facing lenses, one example being shown in FIG. 3 and discussed below. Any form of camera may be used (e.g., fish eye, zoom lens, etc.). In this embodiment, the plurality of holes 26 is in the form of eight holes spaced evenly apart. However, any number of holes may be implemented, so long as full perimeter image capture is enabled, as determined by one skilled in the art. Furthermore, any form of optical window may be implemented, e.g., an annular cutout along the entire annular sidewall 24, etc. The electronics may be designed to allow the image capture to be independent of the orientation of the puck in case the puck flips. In some embodiments, the holes may include angles, chamfers, notches, etc. or any form of structural shaping that benefits image capture, so that the camera(s) can “look” upwardly, or in any desired direction. Those skilled in the art will appreciate that the electronics can be placed anywhere in or attached to the puck body 20. The present invention is contemplated to endure the rigors of the hostile environment on the field/rink. The puck body 20 may be both airtight and watertight and is designed to endure shock, vibration and temperature extremes.

Except for the small apertures of the optical windows which protect the cameras 28 and their lenses, the outward appearance of the instrumented hockey puck 20 may be identical to the conventional ice hockey puck so it will not be obtrusive to the game or to the players. In some embodiments, the dynamics of the instrumented hockey puck 20 are made identical to the dynamics of the conventional ice hockey puck. The instrumented ice hockey puck material may be formed of vulcanized hard black rubber just like the conventional regulation hockey puck. However, other materials may be used to manufacture the puck, either instead of or in combination with the black rubber. For example, materials used may include various plastic polymers such as PVC or similar, other forms of rubber, or any other materials known in the art. Similarly, the puck may or may not be black in color like a standard puck, and may be any desired color, and include any desired indicia or designs, including engraved or embossed designs. The weight of the instrumented hockey puck 20 may be 5.5 to 6.0 ounces which is the regulation weight of conventional ice hockey pucks.

However, in other embodiments, the puck may be a different weight than the regulation weight, e.g., anywhere between 3-9 ounces, or any other weight considered suitable by one skilled in the art.

Furthermore, in some embodiments, the puck's moments of inertia may be made identical to the conventional regulation ice hockey puck by appropriately balancing and distributing its weight and the weight of its internal components around its x, y and z axes respectively. Voids in the vulcanized hard black rubber molding and encapsulating material may be deliberately made at locations inside the body of the puck to achieve these moments of inertia. Small counter weights may also be implemented, which may be made of high-density rubber or thermoplastic composites, steel, brass, or other materials. Furthermore, the hockey puck 20 may be three inches in diameter and one inch thick. The distance between the instrumented ice hockey puck's top and bottom surfaces may be one inch, like conventional regulation ice hockey pucks. However, any measurements may be incorporated for various training or entertainment purposes, e.g., the diameter may be anywhere between 2-6 inches in diameter, and the thickness may be anywhere from 0.5 to 3 inches, which should be considered within the scope of the present invention.

While the present example of an ice hockey puck 20 is illustrated and described, it should be understood that any form of hockey puck may be constructed within the scope of the invention as-claimed. For example, the puck 20 and/or rink/field may be adapted to be used in roller hockey, street hockey, or any similar form of sport. In the embodiment of a roller hockey puck (not shown), the puck may comprise a durable central body formed of an impact-resistant polymeric material and a plurality of low-friction glide elements disposed around its periphery to facilitate smooth translational motion over indoor and outdoor playing surfaces. In an embodiment where the puck 20 is used in street hockey, it may be configured to optimize performance on rough, uneven, or abrasive outdoor surfaces such as asphalt or concrete.

As shown in FIG. 2, the transmittal device 48 of the hockey puck 20 allows images captured by the camera(s) 28 to be transmitted to the user device 60, the display device 40, and the central computer 50 via the network 42. The central computer 50 includes a computer processor 52 and a computer memory 54. The computer memory 54 includes executable code in the form of an imaging program 56 that is discussed at length below. As illustrated, the computer memory 54 further includes or connects to a database 58 for storing data, also discussed in greater detail below.

As shown in FIG. 2, the user device 60 also includes a computer processor 62 and a computer memory 64, wherein the computer memory 64 may store a downloadable application 66 (a.k.a., “app”) that communicates with the central computer 50 via the network 42 to run the imaging program 56. The computer memory 64 may also include a browser 68 which may alternatively be used to interact with the imaging program 56. In this embodiment, the central computer 50 and/or the customer device 60 may further be capable of communicating with the display device 40 or a third party computer (not shown) via the network 42. The display device 40 may be in the form of any type of display, e.g., a smart TV, a projector, etc., or it may be part of the user device 60 (such as the screen of a smart phone/tablet device). The images acquired by the camera(s) 28 may be captured via a closed circuit bi-directional RF wireless and/or fiber optics cable transmitting and receiving network to a remote base station via an antenna array relay junction. The images are processed and formatted by the imaging program 56 of the central computer 50, thus preparing them for presentation on the display device 40 and/or the user device 60. The resulting images may be in the form of pictures, video, a 3D model, etc., or any other useful format, which may be in the form of a file, or it may be streamed to the user device 60 and/or the display device 40. The images may be used for training purposes, entertainment purposes, or other uses, discussed in greater detail below. In some embodiments, microphone(s) (not shown) may also be included within the hockey puck 20 for capturing audio to be transmitted alongside the images captured by the camera(s) 28.

For purposes of this application, the terms “computer,” “computer device,” “server,” and similar terms, refer to a device and/or system of devices that include at least one computer processor, and some form of computer memory having a capability to store data. The computer may comprise hardware, software, and firmware for receiving, storing, and/or processing data as described below. For example, a computer may comprise any of a wide range of digital electronic devices, including, but not limited to, a server, a desktop computer, a laptop, a smart phone, a tablet, or any form of electronic device capable of functioning as described herein.

The term “computer processor” as used herein refers to an electrical component that performs operations on an external data source, such as a computer memory, typically in the form of a microprocessor, although any equivalent structure may be used.

The term “computer memory” as used herein refers to any tangible, non-transitory storage that participates in providing instructions to a processor for execution. Such a medium may take many forms, including but not limited to, non-volatile media, volatile media, and any equivalent media known in the art. Non-volatile media includes, for example, ROM, magnetic media, and optical storage media. Volatile media includes, for example, DRAM, which typically serves as main memory. Common forms of computer memory include, for example, hard drives and other forms of magnetic media, optical media such as CD-ROM disks, as well as various forms of RAM, ROM, PROM, EPROM, FLASH-EPROM, solid state media such as memory cards, and any other form of memory chip or cartridge, or any other medium from which a computer can read. While several examples are provided above, these examples are not meant to be limiting, but illustrative of several common examples, and any similar or equivalent devices or systems may be used that are known to those skilled in the art.

The term “database” as used herein, refers to any form of one or more (or combination of) relational databases, object-oriented databases, hierarchical databases, network databases, non-relational (e.g. NoSQL) databases, document store databases, in-memory databases, programs, tables, files, lists, or any form of programming structure or structures that function to store data as described herein.

For purposes of this application, as discussed below, any element mentioned in the singular also includes the plural, so it is to be understood that the term “computer processor” also includes multiple processors, and the term “computer memory” includes multiple memory devices, and either of which may be configured in any manner known in the art (i.e., in a single device, or distributed in any manner known to those skilled in the art). The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The term “streamer” as used herein, refers to any individual, organization (e.g. corporation, LLC, and so on), or computer functioning on behalf of the individual or organization that streams media content. The term “viewer” as used herein, refers to any individual, organization (e.g. corporation, LLC, and so on), or computer functioning on behalf of the individual or organization that may be interested in viewing or otherwise experiencing media streamed by a streamer.

FIG. 3 is an exploded perspective view of the hockey puck 20, showing the electronics chamber 32. As shown in FIG. 3 and discussed above, the puck body 20 may be constructed in such a way that the electronics are within a removable center piece 36 of the puck 20 to allow for easy manufacturing and replacement. However, in other embodiments, the center piece 36 is not removable. In this embodiment, the center piece 36 includes a plurality of arms 38 spaced circumferentially, wherein the arms 38 extend to the cameras 28. The electronics chamber 32 may include a plurality of bores 39 or compartments, or a single annular cutout, or similar, that extend to the plurality of spaced holes 26, so that the arms 38 may pass through the bores 39 and the cameras 28 may see through the holes 26. In some embodiments, the arms 38 are flexible arms for inserting through the bores 39, but alternatively may be rigid. Furthermore, as previously mentioned, there may be other means of disposing the camera(s), different types of cameras and optical windows, and different numbers of cameras/windows, as determined by one skilled in the art.

FIG. 3 also illustrates how the opening 30 of the electronics chamber 32 includes the cover plate 34 for securing and/or sealing the electronic components within the puck body 20. The cover plate 34 may be in the form of a lens to better capture images around the hockey puck 20, or alternatively may be opaque, or transparent without lens elements. The cover plate 34 may screw, snap, or otherwise engage with the puck body 20, and may include some form of release mechanism (not shown) for ease of removal, e.g., a locking tab or pull-tab, press-release mechanism, etc. In alternative embodiments, the cover plate 34 is excluded, and the center piece 36 extends across the opening 30 of the electronics chamber 32 instead.

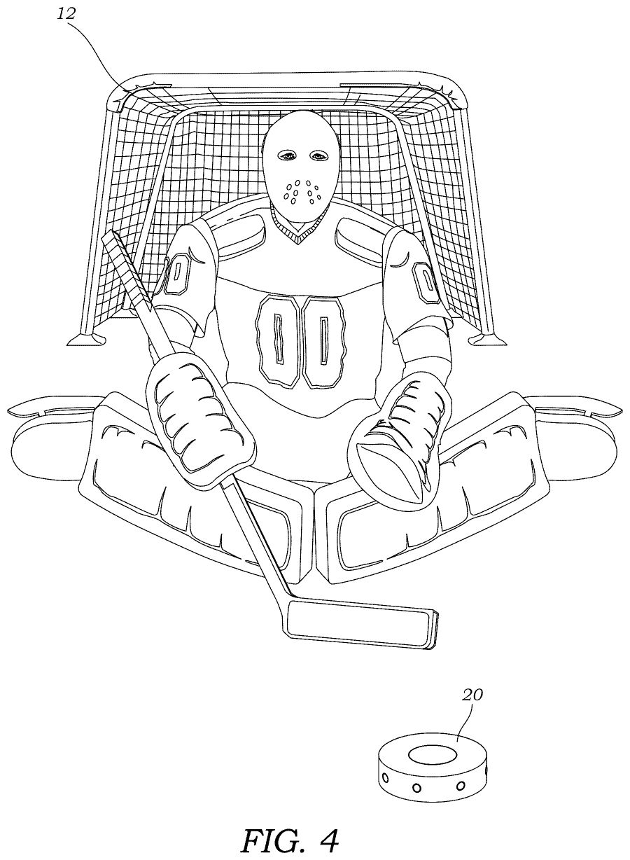

FIG. 4 illustrates a player view of a goal 12 and goalie, with the hockey puck 20 positioned in front of the player. As shown in FIG. 4, to the player, there may appear to be space between the goalie and the goal 12 which may be viewed as a good place to attempt to score a goal.

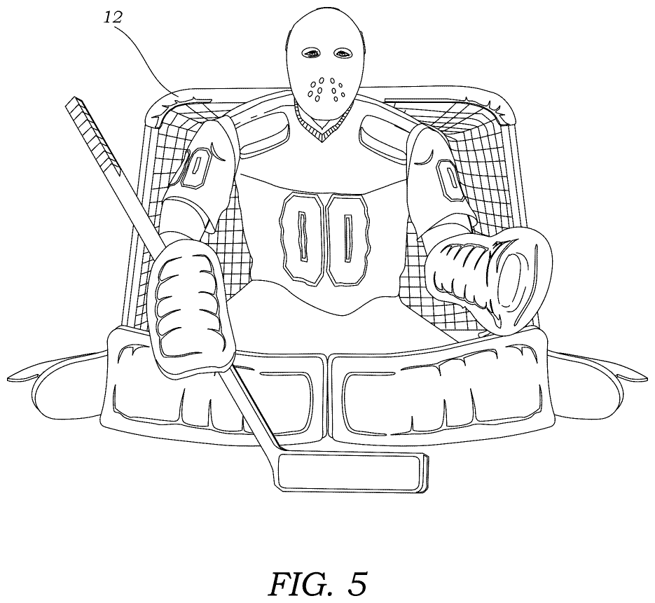

FIG. 5 illustrates the same view of the goal 12 and the goalie shown in FIG. 3, but from the perspective of one of the cameras 28 of the hockey puck 20, which may be shown on the display 40 of FIG. 2. As shown in FIGS. 4-5, the system 10 may be used to view gameplay from the vantage point of the cameras 28 in the hockey puck 20. FIG. 4 illustrates what a hockey player might see before attempting a shot at a hockey goal. As shown in FIG. 4, from the player's perspective, it would appear that there is an opening on the left side of the goal 12. However, when shown from the puck's perspective as in FIG. 5, it becomes clear that the opening is an illusion, and this is not a good shot to take. The two different perspectives demonstrate the difference in view point from the shooter's eyes to the actual position of the puck 20. The cameras 28 mounted in the puck 20 would show a completely different perspective on shooting angles as compared to what a shooter would see with their own eyes. In this manner, the perspective of the puck 20 can be very useful for training purposes. The addition of multiple optical holes 26 or similar openings within the annular sidewall 24 of the puck means that images may be captured in 360 degrees, to ensure that the desired view is always included.

For example, the cameras 28 of the puck 20 may capture images prior to a goal attempt, and transmit the images captured via the transmittal device 48, where it can be viewed on the display device 40. As previously described, the display device 40 may be part of the user device 60, or it may be a separate component. A coach might view the perspective of the puck 20 while the player is on the ice, and give real-time guidance based on what is displayed. The player might also use this to train alone, and view the footage after attempting a shot. While the hockey puck with camera system 10 may be especially useful for angles of shooting/passing, the images may be used for other purposes, such as different forms of training, or for entertainment. The images may be viewed by the coach/players, and the images may additionally or instead be streamed for viewing by remote viewers.

The imaging program and the downloadable app may include features for stitching 360 degree footage together, for reducing motion blur of captures, for image stabilization, etc. It may also include AI software that automatically selects the correct camera, and determines which direction is “forward” based on the images or based on motion sensors. AI software may further assist with image selection, and choose the best images/videos to display to the user. The imaging program may be otherwise processed and formatted, thus preparing them for viewing; processing and formatting included may be HD, 3-D, upright and stabilized pictures, or any other processes known to those skilled in the art. The user may also have the option of manually editing and selecting footage, as well as sharing selected footage. A large variety of possible features may be implemented in the imaging program/downloadable app, limited only to the imagination of the programmer.

In addition to the motion sensors mentioned above, in some embodiments, other forms of sensors may be implemented. For example, a temperature sensor, speed sensor, light sensor, pressure sensor, proximity sensor, acoustic sensor, or any other type of sensor that may benefit the usefulness of the present invention.

Besides professional league games, the present invention contemplates a variety of venues like college and high school sporting events and training sessions. The cameras 28 can be of different types, yielding picture formats such as still frame photographs, freeze frame, full motion video, real time video, SD/HD real time video, and 3-D SD/HD real time video. The present invention contemplates enhancing the enjoyment of sports events, demonstration games, player training and warm-up sessions by other live audiences besides live TV viewing audiences. Examples of such audiences are those streaming on the internet, those viewing live general displays in stadiums, those reviewing reproductions of all the intimate details of the game that were too numerous to broadcast in real time, and instant replay judges/umpires etc.

The title of the present application, and the claims presented, do not limit what may be claimed in the future, based upon and supported by the present application. Furthermore, any features shown in any of the drawings may be combined with any features from any other drawings to form an invention which may be claimed.

As used in this application, the words “a,” “an,” and “one” are defined to include one or more of the referenced item unless specifically stated otherwise. The terms “approximately” and “about” are defined to mean +/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A hockey puck with camera system for capturing images from a playing surface and transmitting the images to a display device, the hockey puck with camera system comprising:
a puck body with a top surface and a bottom surface that are joined by an annular outer perimeter;
at least one opening through the annular outer perimeter and into an electronics chamber within the puck body; and
wherein the electronics chamber contains at least one camera that can collect light through the at least one opening, and a transmittal device for transmitting images taken by the at least one camera to the display device.

2. The hockey puck with camera system of claim 1, further including an access opening in the puck body that gives access to an electronics chamber within the puck body.

3. The hockey puck with camera system of claim 2, wherein the access opening includes a cover plate for covering internal electronics.

4. The hockey puck with camera system of claim 3, wherein the cover plate is in the form of a camera lens.

5. The hockey puck with camera system of claim 1, wherein the at least one opening is in the form of a plurality of spaced holes.

6. The hockey puck with camera system of claim 1, wherein the at least one opening is in the form of an annular window around the annular outer perimeter.

7. The hockey puck with camera system of claim 1, wherein the electronics are within a removable piece of the center of the puck body.

8. The hockey puck with camera system of claim 1, wherein the puck's moments of inertia in use may be made identical to a conventional regulation hockey puck by appropriately balancing and distributing its weight and the weight of its internal components around its x, y and z axes respectively, by adding counterweights and/or forming voids in the materials at locations inside the puck body.

9. The hockey puck with camera system of claim 1, wherein the diameter of the puck body is between 2-6 inches, and the thickness is between 0.5 to 3 inches.

10. The hockey puck with camera system of claim 1, wherein at least one microphone is included within the puck body for capturing audio to be transmitted alongside the images captured by the at least one camera.

11. A hockey puck with camera system for capturing images from a playing surface, the system comprising:
a puck body with a top surface and a bottom surface that are joined by an annular outer perimeter; at least one opening through the annular outer perimeter and into an electronics chamber within the puck body;
the electronics chamber containing at least one camera that can collect light through the at least one opening;
a computer processor and a computer memory connected to the at least one camera, and a transmittal device for transmitting images taken by the at least one camera to a display device and a central computer via a network; and
wherein the central computer includes a computer processor and a computer memory, and the computer memory includes executable code in the form of an imaging program that processes and formats the images for presentation on the display device.

12. The hockey puck with camera system of claim 11, wherein the images acquired by the camera(s) may be captured via a closed circuit bi-directional RF wireless and/or fiber optics cable transmitting and receiving network to a remote base station via an antenna array relay junction.

13. The hockey puck with camera system of claim 11, wherein the imaging program includes AI software that automatically selects the correct camera, and determines which direction is “forward” based on the images or based on motion sensors.

14. The hockey puck with camera system of claim 11, wherein the images are further transmitted to a user device that includes a computer processor and a computer memory, wherein the computer memory may store a downloadable application that communicates with the central computer via the network to run the imaging program.
